(19) United States
(12) Patent Application Publication
(10) Pub. No.: US 2009/0148705 A1
(43) Pub. Date: Jun. 11, 2009

(54) Bullet Proof Structure

(76) Inventor: Chun-Hui CHIANG, Yunlin County (TW)

Correspondence Address: Dr. BANGER SHIA, 102 Lindencrest Ct., Sugar Land, TX, 77479-5201, US

(21) Appl. No.: 11/952,888

(22) Filed: Dec. 7, 2007

(51) Int. Cl. B32B 27/38; B32B 27/08

(52) U.S. Cl. 428/413; 428/451; 428/500

(57) ABSTRACT

A bullet proof structure is essentially made of an acrylic material. Upper and lower surfaces of the acrylic material are evenly coated with a layer of plastic material to protect the acrylic material from being scratched, and the plastic material can be integral with the acrylic material.

### BACKGROUND OF THE INVENTION

1. Field of the Invention

The present invention relates to a bullet proof material, and more particularly to a bullet proof structure which can protect its surfaces from being scraped or worn out.

2. Description of the Prior Art

The conventional bullet proof structure made of acrylic material is able to withstand a shooting and is quite useful. However, it is to be noted that the bullet proof made of acrylic material must be maintained carefully in order to keep its appearance nice and clean, otherwise it may be scraped or worn out easily, causing aesthetic problems. Therefore, an improvement must be made to solve the aforementioned problems.

The present invention has arisen to mitigate and/or obviate the afore-described disadvantages.

### SUMMARY OF THE INVENTION

The primary objective of the present invention is to provide a bullet proof structure. Upper and lower surfaces of the acrylic material are evenly coated with a layer of plastic material to protect the acrylic material from being scratched, and the plastic material can be integral with the acrylic material.

Hence, the present invention provides a bullet proof structure which is made of an acrylic material and is coated with a layer of plastic material on its upper and lower surfaces, and the plastic material is integral with the acrylic material.

### BRIEF DESCRIPTION OF THE DRAWINGS

FIG. 1 is a perspective view in accordance with the present invention; and

FIG. 2 is a cross sectional view in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

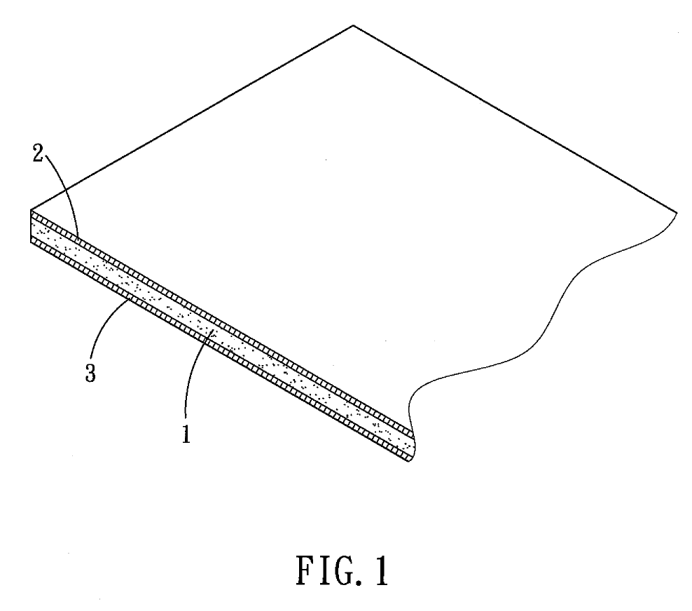

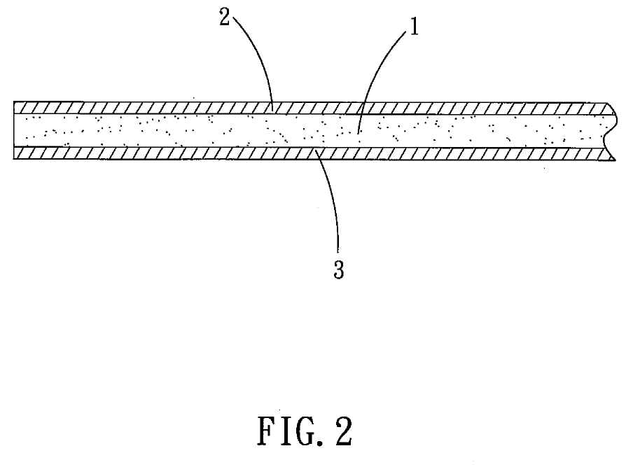

Referring to FIG. 1 and FIG. 2, a bullet proof structure in accordance with the present invention is essentially made of an acrylic material. The so-called acrylic material refers to organic glass or polymethyl methacrylate. It is to be noted that the upper and lower surfaces of the acrylic material 1 are evenly coated with a layer of plastic material 2, 3 to protect the acrylic material 1 from being scratched, and the plastic material 2, 3 can be integral with the acrylic material 1.

In order to insure that the plastic material 2, 3 is indeed capable of protecting the acrylic material 1, the plastic materials 2, 3 are hard coatings. The main raw material of the plastic material 2, 3 is Silicon Dioxide with a total light transmittance of 92 percent or more, and under normal condition, the plastic material 2, 3 can be used for 72 hours continuously without distortion at the temperature of 70 degree and −20 degree.

It is to be noted that the plastic material 2, 3 coated on the upper and lower surfaces of the acrylic material 1 can also be Epoxy or Silica gel which can also protect the acrylic material from being scraped.

What mentioned above is a summary of the positional and structural relationship of the respective components of the preferred embodiment in accordance with the present invention.

To summarize, the upper and lower surfaces of the acrylic material 1 are evenly coated with a layer of plastic material 2, 3 to protect the acrylic material 1 from being scratched, and the plastic material 2, 3 can be integral with the acrylic material 1. While we have shown and described various embodiments in accordance with the present invention, it is clear to those skilled in the art that further embodiments may be made without departing from the scope of the present invention.

What is claimed is:

1. A bullet proof structure comprising:
an acrylic material; and
a layer of plastic material coated on upper and lower surfaces of the acrylic material, the plastic material being integral with the acrylic material.

2. The bullet proof structure as claimed in claim 1, wherein the plastic material is a hard coating.

3. The bullet proof structure as claimed in claim 1, wherein the plastic material is Epoxy.

4. The bullet proof structure as claimed in claim 1, wherein the plastic material is Silica gel.
